(19) United States
(12) Patent Application Publication
(10) Pub. No.: US 2018/0303126 A1
(43) Pub. Date: Oct. 25, 2018

(54) PRESERVATION OF WATER-SOLUBLE VITAMINS

(71) Applicant: YNSECT, Evry Cedex (FR)

(72) Inventors: Antoine HUBERT, Alfortville (FR); Nathalie BEREZINA, Paris (FR); Benjamin ARMENJON, Paris (FR)

(73) Assignee: YNSECT, Evry Cedex (FR)

(21) Appl. No.: 15/769,536

(22) PCT Filed: Oct. 18, 2016
(86) PCT No.: PCT/FR2016/052694

§ 371 Date: Apr. 19, 2018

(30) Foreign Application Priority Data
Oct. 20, 2015 (FR) 1560014

(51) Int. Cl. A23K 10/26; A23K 20/174; A23K 40/10; A23K 20/163; A23L 29/275; A23L 33/15; A23P 10/25

(52) U.S. Cl. CPC A23K 10/26; A23K 20/174; A23K 40/10; A23V 2002/00; A23L 29/275; A23L 33/15; A23P 10/25; A23K 20/163

(57) ABSTRACT

The present invention relates to a method including heat treatment of a composition including chitin and water-soluble vitamins and/or derivatives thereof. The invention also relates to a granule which can be obtained by the method according to the invention, a granule comprising chitin and water-soluble vitamins and/or derivatives thereof, and the use of said granules in human food or animal feed, more particularly in fish feed. Finally, the invention relates to the use of chitin to protect water-soluble vitamins during heat treatment.

The present invention relates to a process comprising a heat treatment of a composition comprising water-soluble vitamins. The invention also relates to the granules (pellets) obtained by the process according to the invention, and the use of these granules in human food or animal feed, in particular in fish feed.

Aquaculture is today one of the most dynamic sectors in the food industry. The high demand for fish has led researchers to develop aquaculture feeds which would allow efficient and rapid farming of fish.

Generally, aquaculture feeds comprise fishmeal. In fact, fishmeal is one of the main sources of proteins in these feeds. It is a meal that is very rich in animal proteins (and in particular rich in amino acids of the lysine and methionine types) that are easy to digest.

The aquaculture feeds can also comprise vitamins. It is well known that vitamins, in particular water-soluble vitamins, play an important role in the development and growth of fish. Thus, vitamins are commonly added during the preparation of aquaculture feeds.

Processes for the preparation of aquaculture feeds, such as extrusion, generally comprise a step of heat treatment at temperatures greater than or equal to 90° C. Unfortunately, this type of heat treatment leads to a degradation of the vitamins, in particular of the water-soluble vitamins, so that the granules obtained have a reduced quantity of vitamins.

A need therefore exists for processes for the preparation of aquaculture feeds, comprising a heat treatment, which would make it possible to avoid or limit the degradation of the water-soluble vitamins during the heat treatment.

The inventors' work has made it possible to demonstrate that it was possible to preserve the water-soluble vitamins during a heat treatment when the latter was carried out under specific conditions.

The present invention thus relates to a process comprising a heat treatment of a composition at a temperature greater than or equal to 90° C., in which the composition comprises at least 0.8% by weight chitin and at least 0.005% by weight water-soluble vitamins and/or derivatives thereof, relative to the total weight of the composition.

It will be noted that, in the context of the present application, and unless otherwise stipulated, the ranges of values indicated are understood to be inclusive.

According to the invention, by “chitin” is meant any type of chitin derivative, i.e. any type of polysaccharide derivative comprising N-acetyl-glucosamine units and D-glucosamine units, in particular chitin-polypeptide copolymers (sometimes referred to as “chitin-polypeptide composite”). These copolymers can also be combined with pigments, often of the melanin type.

Chitin would be the second most-synthesized polymer in the living world, after cellulose. In fact, chitin is synthesized by numerous species in the living world: it constitutes part of the exoskeleton of crustaceans and insects, and the lateral wall which surrounds and protects fungi. More particularly, in insects, chitin thus constitutes 3 to 60% of their exoskeleton. The chitin content can be determined by assay according to the AOAC 991.43 method. Such a method is used in Example 1, and represents a preferred method for this determination.

The chitin present in the composition can result from the introduction of chitin into the composition or, advantageously, from the introduction of an arthropod, cephalopod (such as squid), gastropod, annelid, and/or fungi meal into the composition. More preferentially, the presence of chitin results from the introduction of an insect, crustacean, squid and/or fungi meal, even more preferentially an insect and/or crustacean meal.

Even more preferentially, the chitin present in the composition results from the introduction of an insect meal and optionally of a crustacean meal.

By “insect meal” is meant more particularly a powder prepared from insects. Such a meal can be prepared by a process comprising the following steps:

1. killing the insects,

2. hot or cold pressing of the insects in order to obtain a press cake,

3. drying of the press cake, and

4. grinding of the dried press cake.

This process for the preparation of insect meal is described more fully below.

Step 1: Killing the Insects

This killing step 1 can advantageously be carried out by scalding or by blanching. This step 1 makes it possible to kill the insects while reducing the microbial load (reducing the risk of deterioration and health risk) and inactivating the internal enzymes of the insects which can trigger autolysis, and thus a rapid browning thereof.

For the scalding, the insects, preferably larvae, are thus scalded with water for 2 to 20 minutes, preferentially 5 to 15 minutes. Preferably, the water is at a temperature comprised between 95 to 105° C., preferentially 100° C.

The quantity of water introduced during the scalding is determined as follows: the ratio of the volume of water in mL to the weight in g of insect is advantageously comprised between 0.3 and 10, preferably between 0.5 and 5, more preferentially between 0.7 and 3, even more preferentially of the order of 1.

For the blanching, the insects, preferably larvae, are blanched with steam (steam nozzles or bed) at a temperature comprised between 95 and 105° C., preferentially 98° C. or with water at a temperature comprised between 95 and 105° C., preferentially 100° C. (using spray nozzles) or in mixed mode (water+steam). The residence time in the blanching chamber is comprised between 1 and 15 minutes, preferentially between 3 and 7 minutes.

Step 2: Pressing

The insects originating from the killing step 1 are then placed in a press according to a procedure which makes it possible to press and separate a juice comprising both a fat fraction and a protein fraction.

Preferably, the pressing step makes it possible to obtain a press cake comprising an oil content less than or equal to 20%, preferentially less than or equal to 17%, more preferentially less than or equal to 15%, the percentages by weight being given with respect to the dry weight of press cake.

Similarly, the pressing step makes it possible to obtain a press cake having a dry matter content comprised between 30% and 60%, preferentially comprised between 40% and 55%, and more preferentially comprised between 45% and 55%, the percentages by weight being given with respect to the weight of press cake.

Any press system can be used in order to carry out the pressing step, such as for example a single screw or twin screw press (Angel-type twin screw press) a filter press (Choquenet-type filter press), a platen press, etc. These systems are well known to a person skilled in the art who is able to determine the pressing conditions in order to obtain the abovementioned oil and/or water contents.

In particular, it is possible to carry out hot or cold pressing. Advantageously, the pressing will be carried out hot, which makes it possible to increase the de-oiling of the press cake. In particular, hot pressing makes it possible to obtain a press cake comprising an oil content less than or equal to 17%, preferentially less than or equal to 15%, the percentages by weight being given with respect to the dry weight of press cake.

Step 3: Drying

The press cake is then dried by the standard technologies known to a person skilled in the art. The drying can be direct or indirect (thin layer dryer, “paddle dryer”, “tubular dryer”, “disc-dryer”, etc.) at a temperature comprised between 60° C. and 200° C., for a period of 15 minutes to 24 hours. By way of example, the press cake can be arranged and dried in ventilated/stirred air at a temperature comprised between 80 and 100° C., preferentially at 90° C. for a period comprised between 3 and 7 hours, preferentially 5 hours.

The objective of this drying step is to obtain a press cake having a moisture content comprised between 2 and 15%, preferably between 5 and 10%, even more preferentially between 4 and 8%.

Step 4: Final Grinding

The dried press cake is then placed in a grinder, such as a hammer mill, making it possible to reduce the press cake to particles.

Preferably, on completion of this final grinding, the size of the insect particles is less than 0.5 cm (largest particle size observable using a microscope), preferably of the order of 1 mm.

The insects preferred for the preparation of such a meal are for example the Coleoptera, Diptera, Lepidoptera, Isoptera, Orthoptera, Hymenoptera, Blattoptera, Hemiptera, Heteroptera, Ephemeroptera and Mecoptera, preferably, Coleoptera, Diptera, Orthoptera and Lepidoptera.

Preferentially, the insects are selected from the group constituted by Tenebrio molitor, Hermetia illucens, Galleria mellonella, Alphitobius diaperinus, Zophobas morio, Blabera fusca, Tribolium castaneum, Rhynchophorus ferrugineus, Musca domestica, Chrysomya megacephala, Locusta migratoria, Schistocerca gregaria, Acheta domesticus and Samia ricini and, even more preferentially, T. molitor.

Advantageously, the protein content of the insect meal is high, for example greater than 67% by weight, preferentially greater than 68% by weight, even more preferentially greater than 70% by weight with respect to the total weight of insect meal. By “proteins” is meant the quantity of crude proteins. The quantification of crude proteins is well known to a person skilled in the art. By way of example, the Dumas method may be mentioned.

By “water-soluble vitamins” is meant one or more vitamins that are soluble in water, whether of natural or synthetic origin. Water-soluble vitamins are known to a person skilled in the art. The water-soluble vitamins to which the invention relates are, in particular the group B vitamins such as vitamin B1 (thiamin), vitamin B2 (riboflavin), vitamin B3 (niacin or nicotinic acid), vitamin B5 (pantothenic acid), vitamin B6 (pyridoxin), vitamin B8 (biotin or vitamin H), vitamin B9 (folic acid), vitamin B12 (cobalamin), as well as vitamin C (ascorbic acid). The derivatives of the water-soluble vitamins to which the present invention also relates can be salts thereof. Preferably, the derivatives of the water-soluble vitamins are provitamins. By “provitamins” is meant a substance that can be converted into a vitamin following ingestion by an animal. By way of example, the calcium salt of vitamin B5, i.e. calcium pantothenate, or cyanocobalamine, which is a provitamin of vitamin B12 will be mentioned.

The quantities of vitamins can be determined by methods well known to a person skilled in the art. For example, the quantity of vitamin B6 can be determined according to the standard NF EN 14164. As for the quantity of vitamin B9, it can be determined by HPLC-type liquid chromatography (“High Pressure (Performance) Liquid Chromatoraphy”) or UPLC (“Ultra Pressure (Performance) Liquid Chromatography”) with UV, RI (refraction index) or MS/MS (tandem mass spectrometry) detection. These methods of determination, used in Example 2, are preferred according to the invention.

Throughout the entire application, when no date is specified for a regulation, a standard or a directive, the regulation, standard or directive in force on the date of filing is meant.

The process according to the invention makes it possible to protect the water-soluble vitamins present in the composition during the heat treatment. By “protect” is meant that the process according to the invention makes it possible to avoid or limit the degradation of the water-soluble vitamins present in the composition, in particular during granulation thereof, such as granulation by extrusion. The presence of chitin in the composition makes it possible to protect the water-soluble vitamins present during this heat treatment.

Chitin is generally considered to be a compound that is difficult for animals, in particular fish, to digest. Moreover, chitin is often invoked as a reason for the mixed results in terms of the growth of fish fed with insect meals. However, as demonstrated in Example 4, the presence of chitin in aquaculture feeds has no negative impact on the growth of the fish.

Advantageously, the composition has a residual moisture content comprised between 2 and 15%, preferably between 5 and 10%, more preferentially between 6 and 8%. This moisture content can for example be determined according to the method originating from EC Regulation 152/2009 of Jan. 27, 2009 (103° C./4 h).

According to a first embodiment of the process according to the invention, the composition comprises at least 0.05% by weight group B and group C vitamins and/or derivatives thereof relative to the total weight of the composition, preferably at least 0.1% by weight.

According to a second embodiment of the process according to the invention, the composition comprises at least 0.004% by weight vitamins B6 and/or B9 and/or derivatives thereof relative to the total weight of the composition, preferably at least 0.005% by weight, more preferentially at least 0.006% by weight.

Whatever the embodiment of the process according to the invention, the composition comprises at least 0.8% by weight chitin relative to the total weight of the composition. In fact, the protective effect on water-soluble vitamins can be observed as soon as the composition comprises at least 0.8% by weight chitin relative to the total weight of the composition.

Advantageously, the composition comprises at least 1.5% by weight chitin relative to the total weight of the composition, preferably at least 2% by weight chitin relative to the total weight of the composition, more preferentially at least 2.4% by weight chitin relative to the total weight of the composition.

When the composition comprises at least 1.5% chitin, an increase is noted in the protective effect on water-soluble vitamins, in particular vitamins B6 and/or B9. This effect is even greater when the composition comprises at least 2% chitin, preferably 2.4% chitin. These effects are described more fully in Example 2 below.

In the process according to the invention, the heat treatment is implemented at a temperature greater than or equal to 90° C.

Preferably, the heat treatment is implemented at a temperature greater than or equal to 100° C., more preferentially comprised between 115 and 145° C.

The heat treatment can also be carried out under pressure, said pressure being comprised between 5 and 50 bar.

Advantageously, the process according to the invention is a granulation.

In the context of the present application, by “granulation” is meant a process of assembling particles.

By “granule” is thus meant a product resulting from a process of assembling particles.

Preferably, the process according to the invention is an extrusion. More particularly, the process can be a granulation by extrusion.

According to a preferred embodiment of the invention, the process of granulation by extrusion comprises the following steps:
grinding a composition comprising at least 0.8% by weight chitin and at least 0.005% by weight water-soluble vitamins, relative to the total weight of the composition, in order to obtain a powder;
adding the powder obtained to an extruder;
treating the powder with the extruder at a temperature comprised between 90 and 250° C., and at a specific mechanical energy (SME) comprised between 25 and 100 Wh/kg; and
drying said granules.

By “grinding” is meant any step aimed at obtaining a powder.

Preferably, the particles forming the powder obtained on completion of the grinding have a size comprised between 10 and 850 μm, more preferentially between 100 and 500 μm, even more preferentially between 150 and 350 μm.

By “extruder” is meant any type of extruder. Preferably, the extruder is a single screw or twin screw extruder.

Following the addition of the powder to the extruder and before the heat treatment, the powder can optionally be subjected to a heat pretreatment at a temperature comprised between 25 and 50° C. This heat pretreatment step can be carried out in a particular compartment of the extruder, generally called a preconditioner.

Preferably, the specific mechanical energy is comprised between 35 and 85 Wh/kg, preferentially between 50 and 70 Wh/kg.

The extrusion process according to the invention can also comprise a coating step. By “coating” is meant any step of applying compounds, and in particular liquid-type compounds, to the granule. Generally, the coating step is carried out by spraying these compounds onto the surface of the granule, for example using a coater, for example before the drying step.

Advantageously, the compounds incorporated are oils, such as vegetable oils such as oleaginous (rapeseed) or animal (fish) oils.

Preferably, the chitin present in the composition utilized in the process of granulation by extrusion according to the invention results from the introduction of an arthropod, cephalopod (such as squid), gastropod, annelid, and/or fungi meal into said composition. More preferentially, the chitin results from the introduction of an insect, crustacean, squid and/or fungi meal, even more preferentially an insect and/or crustacean meal.

Even more preferentially, the chitin present in the composition utilized in the process of granulation by extrusion according to the invention results from the introduction of an insect meal and optionally of a crustacean meal.

Preferably, the meal(s) represent between 10 and 75%, preferably between 20 and 60%, more preferentially between 25 and 45% by dry weight of the total weight of the composition utilized in the process of granulation by extrusion according to the invention.

When insect meal is utilized, this advantageously represents between 7 and 50%, preferably between 10 and 40%, even more preferentially between 25 and 35% by dry weight of the total weight of the composition utilized in the process of granulation by extrusion according to the invention.

Preferably, the insect meal is as described above.

The composition utilized in the process of granulation by extrusion according to the invention can also comprise one or more ingredients selected from the group constituted by:
fishmeal,
gluten, such as wheat or maize gluten,
a vegetable flour, such as an oleaginous or proteaginous plant flour, such as soy or pea flour, or such as a cereal flour, such as wheat flour,
oils, such as vegetable oils such as oleaginous (rapeseed) or animal (fish) oils.
minerals,
amino acids such as methionine,
vitamins other than water-soluble vitamins.

However, and as indicated above, the oils can be added after extrusion, during a coating step.

All the preferred characteristics of the heat treatment process according to the invention, as described above, can also be applied to the present preferred embodiment of the invention.

The invention also relates to a second extrusion process of a composition (comprising little or no chitin) comprising the following steps:
addition of at least 0.8% chitin to the composition, the percentage by weight being given with respect to the total weight of the composition, and
extrusion of the composition.

In fact, it has been observed that adding chitin to a composition made it possible to reduce the SME necessary to carry out the extrusion. The invention therefore also relates to the use of chitin to reduce the SME necessary for an extrusion.

The invention also relates to a granule capable of being obtained by the process of granulation by extrusion according to the invention.

The invention also relates to a granule comprising at least 0.6% by weight chitin and at least 0.004% by weight water-soluble vitamins, relative to the total weight of the granule and having an apparent density after drying comprised between 400 and 650 g/L.

Preferably, the granule comprises at least 1% by weight chitin relative to the total weight of granule, more preferentially at least 1.2% by weight chitin relative to the total weight of granule, even more preferentially at least 2% by weight chitin relative to the total weight of granule.

According to a first aspect, the granule comprises at least 0.04% by weight group B and group C vitamins and/or derivatives thereof, relative to the total weight of granule, preferably at least 0.08% by weight group B and group C vitamins and/or derivatives thereof, relative to the total weight of granule.

According to a second aspect, the granule comprises at least 0.004% by weight vitamins B6 and/or B9 relative to the total weight of granule, preferably at least 0.005% by weight vitamins B6 and/or B9, relative to the total weight of granule.

Preferably, the granule will have a size comprised between 1 and 10 mm, preferentially between 1.5 and 5 mm, even more preferentially between 2 and 4 mm.

Advantageously, the chitin present in the granule results from the introduction of an arthropod, cephalopod (such as squid), gastropod, annelid, and/or fungi meal. More preferentially, the chitin results from the introduction of an insect, crustacean, squid and/or fungi meal, even more preferentially an insect and/or crustacean meal.

Even more preferentially, the chitin present in the granule results from the introduction of an insect meal and optionally a crustacean meal.

Advantageously, the granule comprises between 6 and 75%, preferably between 15 and 55%, more preferentially between 25 and 45% by dry weight meal(s), relative to the total weight of granule.

Preferably, the granule comprises between 6 and 50%, preferably between 10 and 40%, even more preferentially between 20 and 30% by dry weight insect meal, relative to the total weight of granule.

Preferably, the insect meal is as described above.

The granule can also comprise one or more ingredients selected from the group constituted by:
fishmeal,
gluten, such as wheat or maize gluten,
a vegetable flour, such as an oleaginous or proteaginous plant flour, such as soy or pea flour, or such as a cereal flour, such as wheat flour,
oils, such as vegetable oils such as oleaginous (rapeseed) or animal (fish) oils.
minerals,
amino acids such as methionine,
vitamins other than water-soluble vitamins.

Advantageously, the granule is obtained by extrusion and has the characteristics of a granule obtained by extrusion.

In particular, the granule according to the invention has an apparent density after drying comprised between 400 and 650 g/L, advantageously between 450 and 600 g/L, preferably between 400 and 550 g/L, more preferentially between 400 and 550 g/L, even more preferentially between 400 and 500 g/L.

Preferably, a granule comprising all of the above ingredients (the fishmeal being optional) is particularly suitable for feeding fish.

The invention also relates to the use of a granule according to the invention, in human food or animal feed.

Advantageously, the granule according to the invention is used in food for pets such as dogs, cats, birds and fish.

Preferably, the granule according to the invention is used in feed for poultry (chicken, turkey, any type of game, for example quail, pheasant, bustard), feed for pigs, ruminants (cattle, sheep, goats, horses) or minks, more preferentially in aquaculture (fish, crustaceans, molluscs, shellfish).

The granule according to the invention can also be used as a food supplement.

Finally, the invention relates to the use of chitin for protecting water-soluble vitamins during a heat treatment at a temperature greater than or equal to 90° C.

In particular, the chitin is used for protecting, during said heat treatment, group B and group C vitamins and/or derivatives thereof, and more particularly vitamins B6 and/or B9.

Advantageously, the chitin results from the introduction of a meal of arthropods, cephalopods (such as squid), gastropods, annelids, and/or fungi.

More preferentially, the chitin results from the introduction of an insect, crustacean, squid and/or fungi meal, even more preferentially an insect and/or crustacean meal.

Even more preferentially, the chitin results from the introduction of an insect meal and optionally a crustacean meal.

The insect meal is advantageously as described above.

The invention will be better understood in the light of the following examples, given by way of illustration, with reference to:

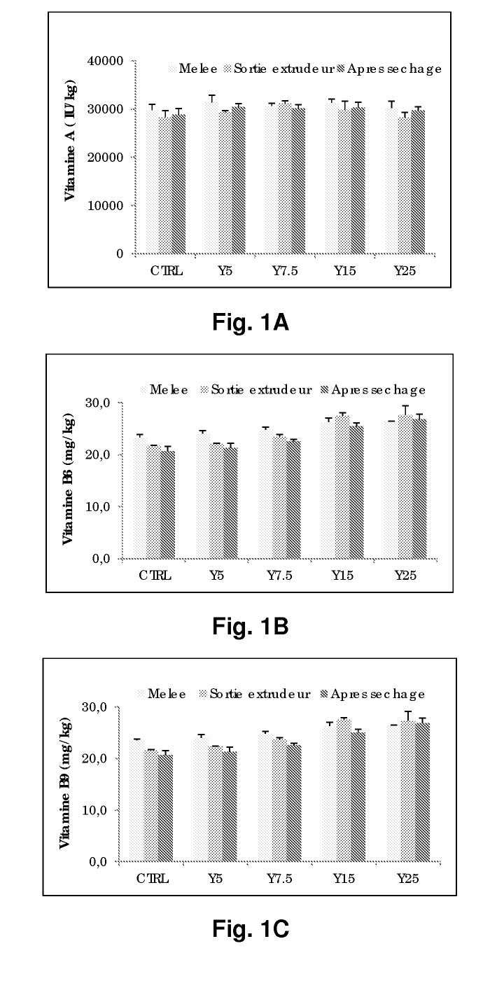

FIG. 1, which comprises three diagrams representing the quantities of vitamins A (FIG. 1A), B6 (FIG. 1B) and B9 (FIG. 1C) in granules obtained according to the process according to the invention, and in granules obtained according to a comparative process;

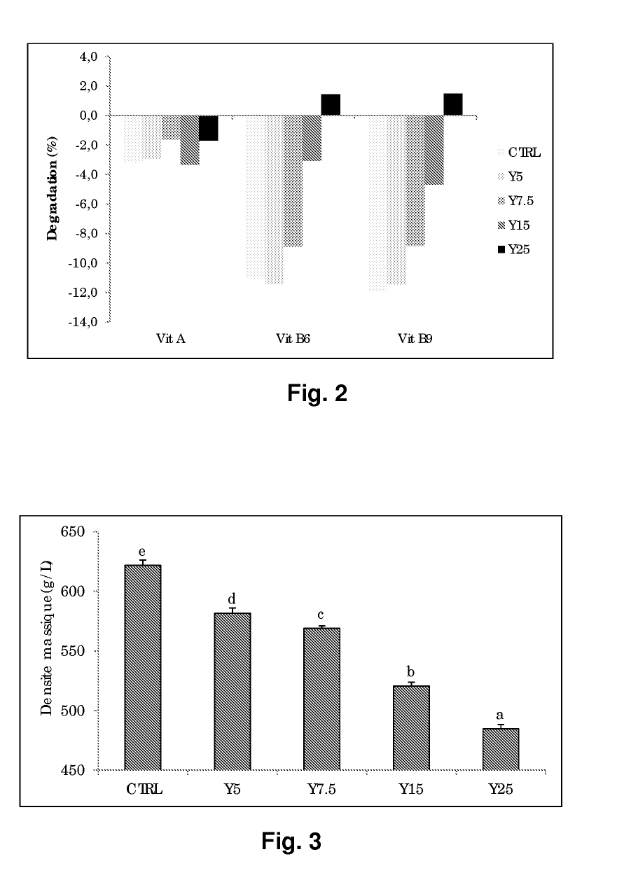

FIG. 2, which is a diagram representing the percentage loss of vitamin A, B6 and B9 with the process according to the invention and with the comparative process;

FIG. 3, which is a diagram representing the mass density of granules obtained according to the process according to the invention, and granules obtained according to a comparative process.

### EXAMPLE 1

### Process According to the Invention and Comparative Process

### 1. Material and Methods

### 1.1. Material

Ingredients for Preparing the Compositions to be Granulated

Insect Meal

A mechanically defatted insect meal is obtained by treatment of Tenebrio molitor larvae. The composition of this meal is presented in Table 1 below.

TABLE 1
Composition of the insect meal used in Example 1

| | Unit | Insect meal |
|---|---|---|
| Moisture | %* | 5.3 |
| Protein | %* | 67.1 |
| Fat | %* | 13.6 |
| Fibre | %* | 1.6 |
| Ash | %* | 3.2 |
| Chitin | %* | 8.0 |
| Energy | MJ/kg | 23.7 |

*The % s are expressed in dry weight relative to the total weight of meal.

Other Ingredients
Fishmeal LT70 (Peruvian fishmeal LT70: 71% crude proteins (CP), 11% crude lipids (CL), EXALMAR, Peru)
Krill meal (2 to 4% chitin) (Krill meal: 61% CP, 19% CL, Aker BioMarine Antarctic AS, Norway)
Squid meal (Super Prime without viscera: 82% CP, 3.5% CL, Sopropeche, France)
Soy protein concentrate (Soycomil P: 62% CP, 0.7% CL, ADM, Netherlands)
Wheat gluten (VITEN: 84.7% CP, 1.3% CL, ROQUETTE, France)
Maize gluten (Maize gluten meal: 61% CP, 6% CL, COPAM, Portugal)
Soy meal 48
Whole pea
Fish oil
Rapeseed oil
Pre-mix of vitamins and minerals (PREMIX Lda, Portugal)
Soy lecithin
Guar gum
Antioxidant
Sodium propionate
Monocalcium phosphate
DL-methionine

Machine for Heat Treatment

The heat treatment is carried out with a twin screw extruder (CLEXTRAL BC45, France) with a screw diameter of 55.5 mm and a maximum flow rate of the order of 90-100 kg/h. The extruder has been equipped with a round die of size 1 mm and a high-speed cutter for cutting the products to the defined granule size.

Other Equipment

Mixing is carried out in a twin propeller mixer (model 500L, TGC Extrusion, France).

Grinding is carried out in a micro-pulverizing hammer mill (model SH1, Hosokawa-Alpine, Germany).

Drying is carried out using a vibrating fluidized bed dryer (model DR100, TGC Extrusion, France).

Coating is carried out in a coater (model PG-10VCLAB, Dinnisen, Netherlands).

### 1.2. Methods

Preparation of the Compositions

Three compositions Y7.5, Y15 and Y25 were formulated, comprising respectively 7.5%, 15% and 25% by dry weight insect meal with respect to the total weight of the composition. These three compositions were utilized in the processes according to the invention. Two other compositions CTRL and Y5 were also formulated for utilization in comparative processes.

Certain adjustments were made to the formulation of the compositions in order to maintain the isonitrogenous conditions (crude protein, 48.5% by dry weight with respect to the total weight of dry matter (DM)), isolipidic conditions (22.7% by dry weight with respect to the total weight of the DM) and isoenergetic conditions (raw energy, 23.2 MJ/kg of DM).

All the ingredients (with the exception of the fish and rapeseed oils) were weighed and mixed in the twin propeller mixer according to the different formulations.

The different mixtures obtained were ground in the micro-pulverizing hammer mill in order to obtain the compositions CTRL, Y5, Y7.5, Y15 and Y20, in the form of powder, the particles of which are smaller than 250 microns in size.

60 kg of each composition were prepared.

The formulations of the compositions are summarized in Table 2 below.

TABLE 2
Summary of the compositions prepared.

| Ingredients in %*: | CTRL | Y5 | Y7.5 | Y15 | Y25 |
|---|---|---|---|---|---|
| Fishmeal LT70 | 25.00 | 20.00 | 17.50 | 10.00 | 0.00 |
| Krill meal | 3.00 | 3.00 | 3.00 | 3.00 | 3.00 |
| Squid meal | 5.00 | 5.00 | 5.00 | 5.00 | 5.00 |
| Insect meal | | 5.00 | 7.50 | 15.00 | 25.00 |
| Soy protein concentrate | 14.00 | 14.00 | 14.00 | 14.00 | 14.00 |
| Wheat gluten | 9.05 | 9.25 | 9.40 | 9.65 | 10.10 |
| Maize gluten | 8.20 | 8.20 | 8.20 | 8.20 | 8.20 |
| Soy meal 48 | 7.50 | 7.50 | 7.50 | 7.50 | 7.50 |
| Whole pea | 6.15 | 5.75 | 5.40 | 4.75 | 3.70 |
| Fish oil | 11.50 | 11.50 | 11.50 | 11.50 | 11.50 |
| Rapeseed oil | 6.00 | 5.80 | 5.70 | 5.40 | 5.00 |
| Pre-mix of vitamins and minerals | 1.50 | 1.50 | 1.50 | 1.50 | 1.50 |
| Soy lecithin | 1.00 | 1.00 | 1.00 | 1.00 | 1.00 |
| Guar gum | 0.20 | 0.20 | 0.20 | 0.20 | 0.20 |
| Antioxidant | 0.20 | 0.20 | 0.20 | 0.20 | 0.20 |
| Sodium propionate | 0.10 | 0.10 | 0.10 | 0.10 | 0.10 |
| Monocalcium phosphate | 1.30 | 1.70 | 2.00 | 2.60 | 3.50 |
| DL-methionine | 0.30 | 0.30 | 0.30 | 0.40 | 0.50 |
| Dry matter (DM), %* | 93.4 ± 0.0 | 93.1 ± 0.0 | 93 ± 0.1 | 95.0 ± 0.0 | 93.2 ± 0.0 |
| Crude protein, % DM** | 48.5 ± 0.0 | 48.5 ± 0.1 | 48.5 ± 0.0 | 48.5 ± 0.0 | 48.5 ± 0.1 |
| Crude fats, % DM** | 22.7 ± 0.2 | 22.7 ± 0.1 | 22.6 ± 0.2 | 22.7 ± 0.2 | 22.7 ± 0.2 |
| Ash, % DM** | 9.4 ± 0.0 | 8.8 ± 0.0 | 8.7 ± 0.1 | 8.1 ± 0.0 | 7.4 ± 0.0 |
| Chitin, % DM** | 0.06 | 0.46 | 0.66 | 1.26 | 2.06 |
| Raw energy, MJ/kg of DM | 23.2 ± 0.2 | 23.2 ± 0.0 | 23.2 ± 0.0 | 23.2 ± 0.1 | 23.2 ± 0.1 |
| Total | 100 | 100 | 100 | 100 | 100 |
| Total without oils (fish and rapeseed) | 82.5 | 82.7 | 82.8 | 83.1 | 83.5 |
| Chitin, % DM without oils (fish and | 0.07 | 0.56 | 0.80 | 1.52 | 2.47 |
| rapeseed) | | | | | |

*% dry matter relative to the total weight of the composition
**% in dry weight relative to the total weight of the dry matter

The pre-mix of vitamins and minerals mentioned in Table 2 comprises:
0.3% by weight vitamin B1 (thiamin),
0.3% by weight vitamin B2 (riboflavin),
0.2% by weight vitamin B6 (pyridoxin),
0.001% by weight provitamin of vitamin B12 (cyanocobalamin),
2% by weight vitamin B3 (nicotinic acid or niacin),
0.15% by weight vitamin B9 (folic acid),
2% vitamin C (ascorbic acid),
0.03% by weight vitamin B8 (biotin or vitamin H), and
1% by weight provitamin of vitamin B5 (calcium pantothenate),
   the percentages by weight being indicated relative to the total weight of the pre-mix of vitamins and minerals.

The compositions CTRL, Y5, Y7.5, Y15 and Y25 thus comprise approximately 0.11% % by weight water-soluble vitamins and/or derivatives thereof, of which 0.006% by weight vitamins B6 and B9, relative to the total weight without oils (fish and rapeseed) of the composition.

Determination of the Quantity of Chitin

Dietary fibres from insect meal are essentially composed of chitin, the latter was therefore assayed according to the AOAC 991.43 method. The values thus obtained are consequently slightly overestimated.

Heat Treatment of the Compositions

The compositions CTRL, Y5, Y7.5, Y15 and Y25 were then extruded with a granule size of 3.0 mm.

Heat Treatment

The temperature of the heat treatment carried out during the extrusion is indicated in Table 3 below, for each composition.

Throughout the extrusion of the different compositions, the operating parameters were recorded and made it possible to calculate the specific mechanical energy (SME), in Watt-hour/kg (Wh/kg).

TABLE 3
Conditions for the extrusion and SME in Example 1.

| | Temp. | Temp. | Supply | Screw | Water | | |
|---|---|---|---|---|---|---|---|
| | Drum 1 | Drum 2 | rate | speed | level | Amperage | SME |
| Diet | (° C.) | (° C.) | (kg/h) | (rpm) | (0-10) | (A) | (Wh/kg) |
| CTRL | 32-33 | 120-123 | 87 | 234 | 7.0 | 15 | 66.0 |
| Y5 | 32-33 | 120-122 | 90 | 240 | 7.0 | 15 | 65.5 |
| Y7.5 | 32-33 | 119-121 | 90 | 245 | 7.0 | 14 | 62.4 |
| Y15 | 32-33 | 119-122 | 93 | 252 | 6.5 | 13 | 57.7 |
| Y25 | 32-33 | 120-123 | 95 | 257 | 6.0 | 13 | 57.6 |

By “Drum 1” is meant a preconditioner, where the mixture originating from the twin screw mixer is brought up to temperature.

By “Drum 2” is meant a conditioner: this is the heat treatment and pressure increase step which takes place in the extruder.

The water level is an indication of the water added during heating with steam and consequently the quantity added can vary according to the ingredients. It is adjusted by drying on completion of the process.

The SME was calculated as follows:

$$SME ( Wh \text{/} kg ) = \frac{U \times I \times cos Φ \frac{ESS SS}{Max SS}}{Qs}$$

Where:

U: operating voltage of the motor (U=460 V).

I: current supplying the motor (A).

cos ϕ: theoretical yield of the motor of the extruder (cos φ=0.95).

ESS SS: test speed (rpm) of the screws in rotation.

Max SS: maximum speed (267 rpm) of the screws in rotation.

Qs: inlet flow rate of the composition (kg/h).

Drying

Following the extrusion, the extrudates CTRL, Y5, Y7.5, Y15 and Y25 were dried in the vibrating fluidized bed dryer.

Coating

After cooling the granules Y7.5, Y15 and Y25, the fish and rapeseed oils described in Table 2 were added by coating under vacuum, using a coater.

### 2. Conclusion

During the extrusion process, increasing doses of insect meal require a reduction in the water added and an increase in the supply rates of the mix and the screw speed, leading to a reduction in the specific mechanical energy (SME).

### EXAMPLE 2

### Evaluation of the Water-Soluble Vitamins in Granules Obtained According to the Process According to the Invention and According to Comparative Processes

In order to determine the effect on the preservation of the water-soluble vitamins, samples of the compositions CTRL, Y5, Y7.5, Y15 and Y25 before extrusion, of the extrudates CTRL, Y5, Y7.5, Y15 and Y25 (before drying) and of dried granules CTRL, Y5, Y7.5, Y15 and Y25 (without coating/covering) were sampled for analysis of the vitamin A, B6 and B9 content.

### 1. Material and Methods

The quantity of vitamin B6 was determined according to the standard NF EN 14164.

The quantity of vitamin B9 was determined by HPLC-type or UPLC-type liquid chromatography with UV, RI (refraction index) or MS/MS (tandem mass spectrometry) detection.

The results of these analyses are presented in Table 4 below.

TABLE 4
Quantities of vitamins A, B6 and B9 at various
stages of the granulation process

| | Composition | | Dry granule |
|---|---|---|---|
| | before extrusion | Extrudate | (without coating) |
| Vitamin A | | | |
| (IU/kg) | | | |
| CTRL | 29750 ± 1219 | 28300 ± 1395 | 28808 ± 1303 |
| Y5 | 31395 ± 1445 | 29382 ± 325 | 30463 ± 648 |
| Y7.5 | 30625 ± 601 | 31183 ± 550 | 30129 ± 800 |
| Y15 | 31331 ± 761 | 29857 ± 1762 | 30287 ± 1150 |
| Y25 | 30210 ± 1454 | 28290 ± 1018 | 29699 ± 752 |
| Vitamin B6 | | | |
| (mg/kg*) | | | |
| CTRL | 23.3 ± 0.6 | 21.7 ± 0.1 | 20.7 ± 0.9 |
| Y5 | 24.1 ± 0.6 | 22.1 ± 0.1 | 21.3 ± 0.9 |
| Y7.5 | 24.8 ± 0.5 | 23.5 ± 0.4 | 22.6 ± 0.4 |
| Y15 | 26.3 ± 0.7 | 27.5 ± 0.6 | 25.5 ± 0.6 |
| Y25 | 26.4 ± 0.0 | 27.6 ± 1.8 | 26.8 ± 1.0 |
| Vitamin B9 | | | |
| (mg/kg*) | | | |
| CTRL | 16.7 ± 0.7 | 8.3 ± 0.4 | 13.9 ± 0.8 |
| Y5 | 16.1 ± 1.0 | 10.6 ± 1.4 | 17.2 ± 0.7 |
| Y7.5 | 16.8 ± 1.3 | 12.0 ± 1.7 | 16.8 ± 1.5 |
| Y15 | 17.7 ± 0.2 | 13.4 ± 0.7 | 17.0 ± 0.1 |
| Y25 | 16.6 ± 1.2 | 13.6 ± 1.0 | 17.2 ± 0.2 |

*Weight indicated in mg/kg of composition

The results from Table 4 are shown in FIG. 1.

FIG. 2 shows the percentage of loss of vitamins A, B6 and B9 during the granulation process for each composition CTRL, Y5, Y7.5, Y15 and Y25.

The results show that:
The losses of vitamin A (liposoluble) during the granulation were low (2-3%) and the vitamin A was scarcely affected by the presence of chitin.
In a CTRL diet, the losses of vitamins B6 and B9 (water-soluble) during the extrusion varied from 11 to 12%. However, the inclusion of meal containing 15 and 25% chitin tended to significantly reduce the losses during treatment of these two vitamins. This effect of preservation of the water-soluble vitamins can therefore be observed as soon as a chitin content greater than or equal to 0.8% is reached in the composition undergoing the heat treatment, preferably greater than or equal to 1.5%.

### EXAMPLE 3

### Evaluation of the Quality Criteria of the Granules

### 1. Material and Methods

The quality of the granules CTRL, Y5, Y7.5, Y15 and Y25 as prepared in Example 1 was evaluated.

### 1.1. Moisture Content

The moisture content of the extrudate (on the outlet of the extruder and before drying) and of the granules (once dried) was measured, by determining the loss of weight after drying of 10 grams of sample (carried out in triplicate) at 105° C. over 24 h.

### 1.2. Water Activity

The water activity (aw) represents the vapour pressure of a product divided by the vapour pressure of a pure water at the same temperature. The water activity is commonly used as a criterion for characterizing the duration of preservation of the products, as below certain levels, it inhibits the growth of bacteria and moulds. The water activity was measured on feed samples in triplicate (2.5 g) using AquaLab LITE (DECAGON, USA).

### 1.3. Apparent Density

The apparent density of the extruded feed was determined, in triplicate, by filling a pre-weighed plastic volumetric beaker (known volume 1 L) with granules. The excess granules at the top of the plastic beaker were gently scraped off level with the rim. Care was taken to avoid tapping the sample. The plastic beaker was weighed and the apparent density expressed by mass of the sample (g) per volume unit (L).

### 1.4. Statistical Treatment of the Data

The data were analyzed by one-way ANOVA. If appropriate, the averages were compared using the Newman-Keuls test. Statistical significance was tested at P<0.05. All the statistical tests were carried out using the SPSS (v21, IBM, USA) software.

### 2. Results

The results relating to the quality of the different granules are presented in Table 5 below and in FIG. 3.

TABLE 5
Apparent density, moisture content and water
activity of the experimental feeds

| | Apparent | Moisture on | | |
|---|---|---|---|---|
| | density after | the outlet of | Moisture after | Water activity |
| Diet | drying g/L | the extruder % | drying % | after drying |
| CTRL | 622 ± 5 ^{e} | 21.8 ± 0.3 | 6.7 ± 0.1 | 0.528 ± 0.006 |
| Y5 | 582 ± 4 ^{d} | 22.2 ± 0.6 | 6.9 ± 0.1 | 0.532 ± 0.017 |
| Y7.5 | 569 ± 2 ^{c} | 22.2 ± 0.6 | 6.7 ± 0.1 | 0.535 ± 0.009 |
| Y15 | 521 ± 3 ^{b} | 21.8 ± 0.6 | 6.6 ± 0.2 | 0.532 ± 0.003 |
| Y25 | 485 ± 4 ^{a} | 21.6 ± 0.9 | 6.8 ± 0.1 | 0.531 ± 0.004 |

The values are averages ± standard deviation (n = 3).
Different letters in superscript in a column indicate a significant difference (P < 0.05).

### 3. Conclusion

The apparent density of the extruded granules varied considerably, from 622 to 485 g/L. A significant reduction in the apparent density (P<0,05) was closely associated with the increase in growing doses of the insect meal.

Whatever the level of inclusion, the insect meal did not affect the moisture content (measured both before and after drying) and the water activity of the extruded feeds.

It is interesting to note that, for the purpose of maintaining isonitrogenous and isolipidic conditions between the diets, apart from the direct replacement of fish meal with insect meal, the diets rich in insect meal have a slight increase in wheat gluten (from 9.05% in CTRL to 10.10% in Y25) and a reduction in whole peas (from 6.15% in CTRL to 3.70% in Y25). Both wheat gluten and starch originating from whole peas are elements known to affect the expansion and the physical structure of the granules.

### EXAMPLE 4

### Impact of Chitin on Fish Growth

The CTRL diet described in Example 1 was formulated with convenient ingredients in order to meet the known nutritional needs of juvenile rainbow trouts. This CTRL diet is composed 25% of fishmeal, 8% of other protein sources of marine origin (squid meal and krill meal), while the remaining protein sources were a concentrate of soy protein, wheat gluten and maize gluten. On the basis of this formulation, the four diets Y5, Y7.5, Y15 and Y25, also described in Example 1, in which the fishmeal was replaced with the insect meal in respective contents of 20, 30, 60 and 100%, were formulated.

### 1. Material and Methods

### 1.1. Material

The Diets

The 5 diets are constituted by granules having the compositions CTRL, Y5, Y7.5, Y15 and Y25 respectively, as prepared in Example 1.

The levels of squid and krill meal were kept constant among all the diets, in order to guarantee a high palatability. Minor adjustments were made to the formulation of the diets tested in order to maintain the isonitrogenous conditions (crude protein, 48.5% DM), isolipidic conditions (22.7% DM) and isoenergetic conditions (raw energy, 23.2 MJ/kg of DM).

The levels of supplementation with methionine and monocalcium phosphate in the diets tested were adjusted in order to correspond to those found in the CTRL feed.

Throughout the duration of the test, the experimental feeds were stored at ambient temperature, but in a cool, well-ventilated place.

The Fish

Triplicate groups of 35 rainbow trouts (Oncorhynchus mykiss), with an initial body weight (IBW) of 5.01±0.1 g were fed with one of the five experimental diets for 90 days. The fish grew in circular, glass-fibre tanks (volume: 250 L) supplied with a continuous flow of freshwater, at temperatures comprised between 14.1±0.3° C. and levels of dissolved oxygen above 7.4 mg/L (FIG. 1). The fish were subjected to summer conditions with natural photoperiod changes (May-July). The fish were hand-fed to apparent satiety, three times a day (9:00, 14:00 and 18:00) during the week and twice a day at week-ends (10:00 and 16:00), taking the greatest care to avoid wasting the feed. The feed distributed was quantified throughout the study. Anaesthetized fish were weighed individually at the start and at the end of the study and the group was weighed on day 28 and on day 60. At the start, 15 fish from the same initial stock were sampled and stored at −20° C. for subsequent analysis of the whole body composition. After 90 days of experimental feeding, 6 fish from each tank were sampled for the same purpose.

### 1.2. Methods

Criterion for Evaluating Growth and the Use of the Nutrients

IBW (g): Initial body weight.

FBW (g): Final body weight.

Specific growth rate, SGR (%/day): (Ln FBW− Ln IBW)×100/days.

Feed conversion ratio, FCR: gross feed ration/weight gain.

Voluntary feed intake, VFI (% BW/day): (gross feed ration/(IBW+FBW)/2/days)×100.

Protein efficiency ratio (PER): wet weight gain/crude protein intake.

Statistical Analysis

The data are presented by the average of three repetitions+standard deviation. The data were subjected to one-factor analysis of variance. Before ANOVA, the values expressed in % were subjected to an arcsine square root transformation. The statistical significance was tested at a probability level of 0.05. All the statistical tests were carried out using IBM SPSS V21 software.

### 2. Results

Growth Performance

The data on the growth performances, feed conversion and protein efficiency of the rainbow trout fed with the experimental diets for 90 days are reported in Table 6. No deaths occurred during the test.

TABLE 6
Growth performances on day 90

| Diet | CTRL | Y5 | Y7.5 | Y15 | Y25 |
|---|---|---|---|---|---|
| IBW (g): | 5.0 ± 0.1 | 4.9 ± 0.1 | 5.0 ± 0.1 | 5.1 ± 0.1 | 5.1 ± 0.1 |
| FBW (g): | 42.9 ± 1.3 ^{a} | 45.2 ± 1.0 ^{b} | 49.0 ± 0.6 ^{c} | 51. 0 ± 1.4 ^{c} | 55.9 ± 1.0 ^{d} |
| SGR, %/d | 2.39 ± 0.06 ^{a} | 2.47 ± 0.02 ^{b} | 2.54 ± 0.03 ^{b} | 2.56 ± 0.05 ^{b} | 2.67 ± 0.04 ^{c} |
| FCR | 0.93 ± 0.02 ^{b} | 0.83 ± 0.03 ^{a} | 0.80 ± 0.02 ^{a} | 0.79 ± 0.04 ^{a} | 0.79 ±0.02 ^{a} |
| Feed intake, % ABW/d | 1.63 ± 0.04 ^{b} | 1.48 ± 0.05 ^{a} | 1.45 ± 0.04 ^{a} | 1.44 ± 0.07 ^{a} | 1.47 ± 0.05 ^{a} |
| PER | 2.38 ± 0.06 ^{a} | 2.68 ± 0.10 ^{b} | 2.76 ± 0.06 ^{b} | 2.80 ± 0.15 ^{b} | 2.74 ± 0.08 ^{b} |

The values are the averages ± standard deviation (n = 3).
The values within a row with different superscripts differ significantly (P < 0.05).

Incorporation of increasing doses of insect meal (and therefore of increasing doses of chitin) with a concomitant reduction of fishmeal were progressively linked to a significant increase in the bodyweight of the fish. Furthermore, in comparison with the CTRL treatment, all the diets of insect meals led to a significant reduction in the feed intake and a significant increase in the PER (P<0.05). The introduction of chitin into the granules according to the invention therefore has no drawbacks as regards the nutritional intake delivered to the animal.

1. Process comprising a heat treatment of a composition at a temperature greater than or equal to 90° C., in which the composition comprises at least 0.8% by weight chitin and at least 0.005% by weight water-soluble vitamins and/or derivatives thereof, relative to the total weight of the composition.

2. Process according to claim 1, in which the composition comprises at least 0.05% by weight group B and group C vitamins and/or derivatives thereof, relative to the total weight of the composition.

3. Process according to claim 1, in which the composition comprises at least 0.004% by weight vitamins B6 and/or B9 and/or derivatives thereof, relative to the total weight of the composition.

4. Process according to claim 1, in which the composition comprises at least 1.5% by weight chitin relative to the total weight of the composition.

5. Process according to claim 1, in which the temperature is greater than or equal to 100° C.

6. Process according to claim 1, in which the heat treatment is carried out under pressure.

7. Process according to claim 1, in which the process is a granulation.

8. Process according to claim 1, in which the process is an extrusion.

9. Granule capable of being obtained by a process comprising a heat treatment of a composition at a temperature greater than or equal to 90° C., in which the composition comprises at least 0.8% by weight chitin and at least 0.005% by weight water-soluble vitamins and/or derivatives thereof, relative to the total weight of the composition, wherein said process is an extrusion in combination with a granulation.

10. Granule comprising at least 0.6% chitin and at least 0.004% by weight water-soluble vitamins, relative to the total weight of the granule and having an apparent density after drying comprised between 400 and 650 g/L.

11. Use of chitin for protecting water-soluble vitamins during a heat treatment at a temperature greater than or equal to 90° C.

12. Process according to claim 1, in which the chitin results from the introduction of an insect, crustacean, squid and/or fungi meal.

13. Use of a granule according to claim 9, in human food or animal feed.

14. Granule according to claim 10, in which the chitin results from the introduction of an insect, crustacean, squid, and/or fungi meal.

15. Use according to claim 11, in which the chitin results from the introduction of an insect, crustacean, squid, and/or fungi meal.
